(19) United States
(12) Patent Application Publication
(10) Pub. No.: US 2002/0137523 A1
(43) Pub. Date: Sep. 26, 2002

(54) Method and apparatus for providing location based information

(75) Inventor: Frank van Diggelen, San Jose, CA (US)

Correspondence Address: THOMASON, MOSER & PATTERSON, LLP, SUITE 100, 595 SHERWSBURY AVENUE, SHREWSBURY, NJ, 07702, US

(73) Assignee: Global Locate, Inc.

(21) Appl. No.: 09/813,639

(22) Filed: Mar. 21, 2001

(51) Int. Cl. H04Q 7/20

(52) U.S. Cl. 455/456; 455/457

(57) ABSTRACT

A method and apparatus for providing location-based information using a wireless communications system is disclosed. In one embodiment, a message is received from a wireless device containing a request for location-based information. Upon receipt of the message, the location of the wireless device is determined, location-based information is retrieved for the determined location and the location-based information is transmitted to the wireless device.

### BACKGROUND OF THE INVENTION

1. Field of Invention

The present invention relates to wireless devices and services. More particularly, the present invention relates to a method and apparatus for providing location-based information using a “legacy” wireless communications system.

2. Description of the Background Art

Wireless devices, such as cellular phones, pagers and personal digital assistants (PDAs), have become increasingly popular. These wireless devices offer a convenient, portable means for transfer and storage of text, voice, video, and the like.

Many of these wireless devices are configured to provide additional user-friendly features. For example, some wireless devices currently provide location-based information such as the locations of hotels, gas stations and stores in a city or region. To access such location-based information, a user is required to enter into the wireless device the location, e.g., the exact city or town, of the user.

However, a user often is unfamiliar with the exact city or location where location-based information is desired, e.g., if a user is on vacation or is in a newly traveled city. Since the user does not know his exact location, the user cannot enter a location in the city or town and, consequently, cannot utilize a current wireless device to access location-based information.

Therefore, there is a need in the art for a method and apparatus that provides location-based information without entering the location of the wireless device.

### SUMMARY OF THE INVENTION

The invention provides a method and apparatus for providing location-based information using a wireless network or wireless communications system. In one embodiment, the invention provides location-based information to a wireless device in response to a message by the wireless device. Initially, a message is received from a wireless device and a determination is made as to whether the received message contains a request for location-based information. If the received message is determined to contain the request for location-based information, the location of the wireless device is determined, location-based information is retrieved for the determined location and the location-based information is transmitted to the wireless device.

In another embodiment, the invention provides location-based information of a wireless device in response to a message by another message sending device. Initially, a message is received from a message sending device utilized by a first user and a determination is made as to whether the received message contains a request for location-based information representative of a location of a second user carrying wireless device. If the received message is determined to contain the request for location-based information, the location of the wireless device is determined, location-based information is retrieved for the determined location, and the location-based information is transmitted to the message sending device.

### BRIEF DESCRIPTION OF DRAWINGS

The teachings of the present invention may be readily understood by considering the following detailed description in conjunction with the accompanying drawings, in which:

FIG. 1 depicts one embodiment of a system for providing location-based information to a user of a wireless device;

FIG. 2 depicts another embodiment of the system for providing location-based information to a user of a wireless device;

FIG. 3 depicts a flowchart of a method for implementing the system of FIGS. 1-2;

FIG. 4 depicts one embodiment of a system for providing location-based information of a user of a wireless device in response to a message from another user; and

FIG. 5 depicts a flowchart of a method for implementing the system of FIG. 4.

To facilitate understanding, identical reference numerals have been used, where possible, to designate identical elements that are common to the figures.

### DETAILED DESCRIPTION OF THE INVENTION

The present invention provides method and apparatus for providing location-based information using a wireless network or wireless communications system. More specifically, the present invention enables a user to obtain location-based information with an existing or “legacy” wireless network using existing protocols. A user only needs to initiate a request for location-based information by activating a button or switch on a message sending device, e.g., wireless device or client computer. As such, the user may easily obtain location-based information without the need to enter the location of a wireless device.

In one embodiment, the invention provides location-based information to a wireless device in response to a message by the wireless device. Initially, a message is received from a wireless device and a determination is made as to whether the received message contains a request for location-based information. If the received message is determined to contain the request for location-based information, the location of the wireless device is determined, location-based information is retrieved for the determined location and the location-based information is transmitted to the wireless device.

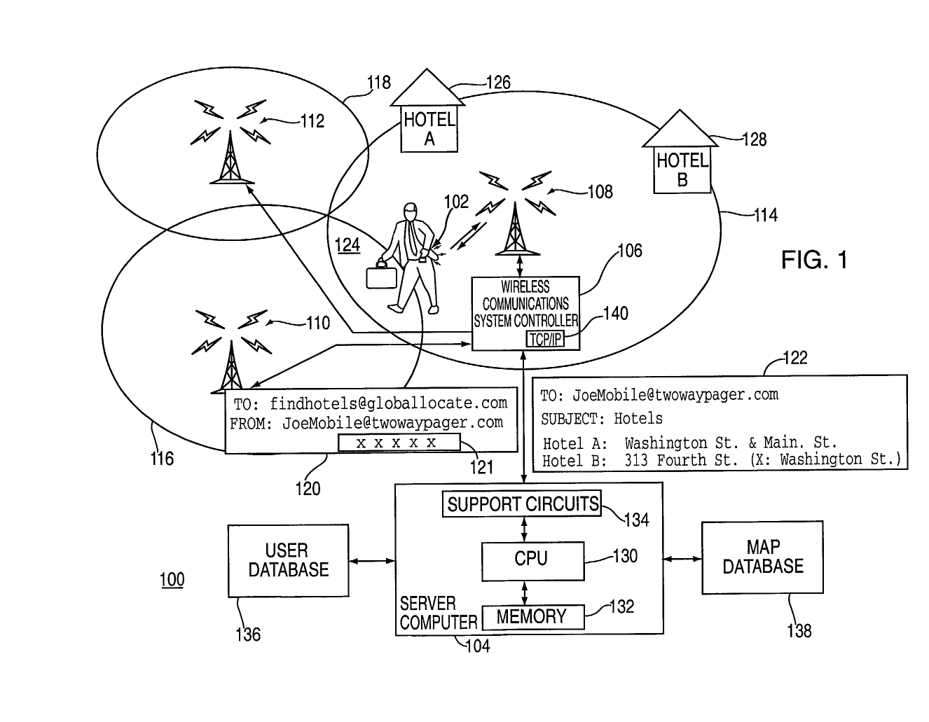

FIG. 1 depicts one embodiment of a system 100 for providing “location-based information” to a user of a wireless device. As an illustrative example, FIG. 1 will describe the transmission of hotel information to a two-way pager. However, those skilled in the art will realize that the present invention may also apply to different types of wireless devices, e.g., cordless phones, portable Personal Digital Assistant (PDA) devices and two-way pagers. Moreover, the present invention may also apply to other types of location-based information, e.g., locations of gas stations, cinemas and the like, in an area near the wireless device, or a map of the area near the wireless device.

The system 100 generally comprises a wireless device 102, a server computer 104, a wireless communications controller 106 and a plurality of communications towers 108, 110 and 112. The wireless communications controller 106 and the communications towers 108, 110 and 112 form a portion of a wireless network or wireless communications system. Each of the communications towers 108, 110 and 112 receives and transmits wireless signals between the wireless communications controller 106 and wireless devices located in a specific region or cell. For example, towers 108, 110 and 112 receive and transmit wireless signals to wireless devices in respective regions 114, 116 and 118.

The wireless device 102 comprises any two-way mobile device capable of using the wireless network to transmit and receive a wireless signal to and from the server computer 104. The wireless signal may comprise a message 120 or a reply message 122. One format of the message 120 and the reply message 122 is an electronic mail (e-mail) message sent in accordance to a protocol, e.g., Transmission Control Protocol/Internet Protocol (TCP/IP). Examples of such two-way wireless devices 102 include a two-way pager, a cellular telephone, and a PDA device.

The wireless device 102 sends the message 120, e.g., an e-mail message addressed to the server computer 104. The message 120 may contain a request for location-based information from the server computer 104 back to the wireless device 102. The request may be configured as a pre-defined character string 121 in different portions of the message 120. For example, the character string 121 may be contained in the header, a TO: field, a CC: field, or the body of the message 120. The character string 121 is represented in the message 120 as a text format, a binary format, and the like.

The message 120 is sent to a predefined TCP/IP address indicative of a desired type of location-based information. For example, if hotel information is desired from a server computer 104 at Is address globallocate.com, the message 120 is addressed to findhotels@globallocate.com. The type of location-based information desired is generally selected from a list or menu display on the wireless device 102. A user selects the desired type of location-based information and pushes a button or selecting some other activating feature, e.g., a switch, to send the message 120 to the server computer 104 via the wireless network. In this configuration of the message 120, the user would no longer need to enter the location of the wireless device 102 to obtain location-based information from the server computer 104.

The wireless device 102 also receives a reply message 122 from the server computer 104. The reply message 122 contains location-based information obtained by the server computer 104 in response to the type of location-based information requested in the message 120. Although the location-based information may comprise a listing of hotels 126 and 128 proximate to the wireless device 102, such location-based information may also comprise other types of location-based data. For example, location-based information may comprise locations of cinemas, gas stations, department stores, grocery stores, and the like, proximate the wireless device 102, or a map of an area proximate to the wireless device 102.

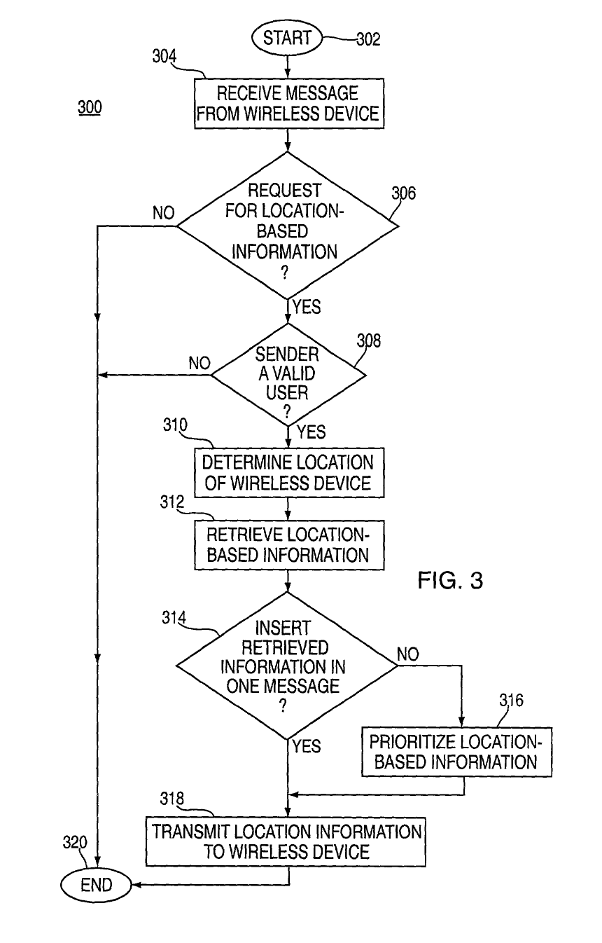

The server computer 104 comprises a central processing unit (CPU) 130, a memory 132 and support circuits 134. The CPU 130 performs the necessary processing functions to implement the server computer 104 of the present invention. A method for implementing the embodiment of FIG. 1 is further described with respect to FIG. 3. The memory 132 stores the software programs to operate the present invention and any associated data structures. The support circuits 134 operate as an interface between the CPU 130 and the wireless communications controller 106. This interface typically comprises a TCP/IP connection.

The server computer 104 is configured to receive the message 120, as a TCP/IP e-mail packet from the wireless controller 106, addressed to a particular IP address, e.g., findhotels@globallocate.com, indicative of a particular type of location-based information. The server computer 104 is also configured to obtain and transmit the desired type of location-based information in the form of a reply message 122 to the wireless device 102.

The server computer 104 may access a user database 136 to verify whether the sender of the message 120 is entitled or permitted to receive location-based information. The server computer 104 may also determine whether the received message 120 contains a request for location-based information, or automatically identify the message 120 as such a request. In one embodiment, the server computer 104 determines whether a pre-defined character string 121 is contained in a particular section, e.g., header, TO: field, CC: field, or body, of the message 120.

The server computer 104 uses the wireless network to determine the location of the wireless device 102. In one embodiment, the server computer 104 determines the location of the wireless device 102. In another embodiment, the server computer 104 obtains the location of the wireless device 102 as obtained by the wireless network.

The present invention does not rely on any specific location determining technique. Any technique that approximates the location of the wireless device 102 can be used. For example, the location of the wireless device 102 may be determined as the location of a communications tower 108 previously receiving a wireless signal from the wireless device. Typically, this location is communications tower 108 closest or most proximate to the wireless device 102. The location of the wireless device 102 may also be determined or approximated from other types of data, e.g., Time of Arrival information, field strength values, Global Positioning System (GPS) and the like.

The location of the wireless device 102 may be determined from the location of at least two communications towers, e.g., communication towers 108, 110 and 112, previously receiving the wireless signal from the wireless device 102. For example, the location may be calculated or approximated as the average or intersection 124 of the regions 114, 116 and 118. The location of the wireless device 102 may also be determined as the maximum likelihood of the location of the different communication towers 108, 110 and 112.

The server computer 104 uses the location of the wireless device to retrieve location-based information for the determined location of the wireless device 102. This location-based information is obtained from the map database 138 and inserted into the reply message 122. One example of location-based information include the locations of hotels within region 114, the locations of hotel A 126 and hotel B 128 may be retrieved from the map database 138.

The wireless communications system controller 106 receives and transmits wireless signals between the server computer 104 and any of the communications towers 108, 110 and 112. Illustratively, the wireless communications system controller 106 comprises a TCP/IP interface 140 for receiving and transmitting e-mail messages in accordance to the TCP/IP. Although the wireless communications system controller 106 is illustratively shown within region 114, the controller 106 may be within or outside any of the regions 114, 116 and 118.

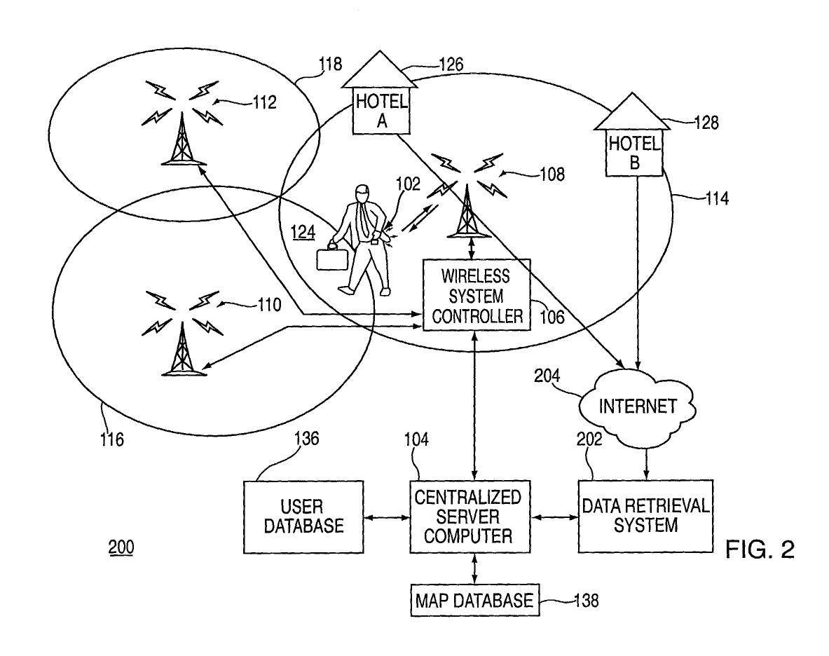

FIG. 2 depicts another system 200 for providing location-based information to a user of the wireless device 102. The system 200 represents another embodiment of the system 100 of FIG. 1. As system 200 operates in substantially the same manner as system 100, only components of system 200 not previously discussed in the system 100 of FIG. 1 are described herein.

In contrast to the system 100 of FIG. 1, the system 200 may also retrieve additional “operating information” of entities listed in the location-based information. For example, the system 200 may retrieve vacancy information of particular hotels or operating hours of a gas station. Such operating information would enable a user of the wireless device 102 to determine whether to visit a particular entity specified in the location-based information.

Specifically, the server computer 104 may provide the operating information with the location-based information in the reply message 122. Upon receipt of a message 120, the server computer 104 may instruct a data retrieval system 202 to retrieve operating information via a network, e.g., the Internet. The data retrieval system 202 illustratively retrieves operating information from hotel A 126 and hotel B 128 within region 114. For example, the reply message 122 may provide whether hotel A 126 or hotel B 128 has any current vacancies. The data retrieval system 202 may comprise a processor, a specific purpose computer, or any combination of processors utilized for retrieving operating information from hotels or other entities to the server computer 104.

The server computer 104 processes the operating information retrieved by the data retrieval system 202. For example, the server computer 104 may provide the status of the entities, e.g., hotels, listed in the location-based information. The server computer 104 may provide only those entities satisfying particular criteria, e.g., only those hotels having vacancies or only those gas stations still open at the time when the request message 120 was sent by the user of the wireless device 102.

FIG. 3 depicts a flowchart of a method 300 for implementing the system 100 of FIG. 1. A slight modification at step 312 is required to implement the system 200 of FIG. 2.

The method 300 starts at step 302 and proceeds to step 304, where a message 120 is received from the wireless device 102 via the wireless network. The message 120 is configured to indicate the type of location-based information selected by the user of the wireless device 102. For example, the desired location-based information includes hotels proximately located to the wireless device 102, the message 120 is addressed to the server computer 104, e.g., findhotels@globallocate.com. The message 120 may contain a request for location-based information. Such a request is configured as a pre-defined character string 121 within the message 120.

At step 306, the method 300 determines whether the message 120 contains a request for location-based information. Step 306 may determine whether the message 120 contains the pre-defined character string 121 indicative of a request. In one embodiment, step 306 may automatically identify the message 120 as a request for location-based information. If the message 120 contains the request for location-based information, the method 300 proceeds to step 308. If the message 120 does not contain the request for location-based information, the method 300 proceeds to end at step 320.

At step 308, a determination is made as to whether the user sending the request message 120, i.e., the user of the wireless device 102, is a valid user of the system 100. Namely, step 308 performs a database query of the user database 136 to determine whether the sender of the message is entitled to receive location-based information. If the user sending the message 120 is not a valid user, the method 300 ends at step 320. If the user sending the message 120 is a valid user, the method 300 proceeds to step 310, where the location of the wireless device 102 is determined.

Step 310 is determined by the server computer 104 or by the wireless communications system controller 106 of the wireless network. Step 310 may be determined by a variety of techniques. One determination of such location is the location of a communications tower 108 previously receiving a wireless signal from the wireless device 102. The location of the wireless device 102 may also be determined or approximated from other types of data, e.g., Time of Arrival information, field strength values, Global Positioning System (GPS) and the like. Additionally, the location of the wireless device 102 may also be determined by determining the location of at least two communications towers 108, 110 and 112 previously receiving the wireless signal from the wireless device 102, and then calculating the intersection, average, or maximum likelihood values of these locations.

The method 300 proceeds to step 312, where location-based information is retrieved for the location of the wireless device 102. For example, step 312 may perform a database query of all the hotels in a region 114, e.g., hotel A 126 and hotel B 128. The result of the database query represents the location-based information extracted from the map database 138. In the system 200 of FIG. 2, step 312 may also extract operating information through the data retrieval system 202.

At step 314, the method determines whether the location-based information from the database query may fit into one reply message 122. Namely, step 314 determines whether the amount of entries or memory requirements of the query results are below a pre-defined limit or threshold value. If all the location-based information would fit into one reply message 122, the method 300 proceeds to step 318. If all the location-based information would not fit into one reply message 122, the method 300 proceeds to step 316, where the location-based information is prioritized according to a default set of user preferences. At step 318, the location-based and (optionally) operating information is provided in the reply message 122 transmitted back to the wireless device 102. After transmitting the reply message 122, the method 300 ends at step 320.

In another embodiment, the invention provides location-based information of a wireless device in response to a message by another message sending device. Initially, a message is received from a message sending device utilized by a first user and a determination is made as to whether the received message contains a request for location-based information representative of a location of a second user carrying wireless device. If the received message is determined to contain the request for location-based information, the location of the wireless device is determined, location-based information is retrieved for the determined location, and the location-based information is transmitted to the message sending device.

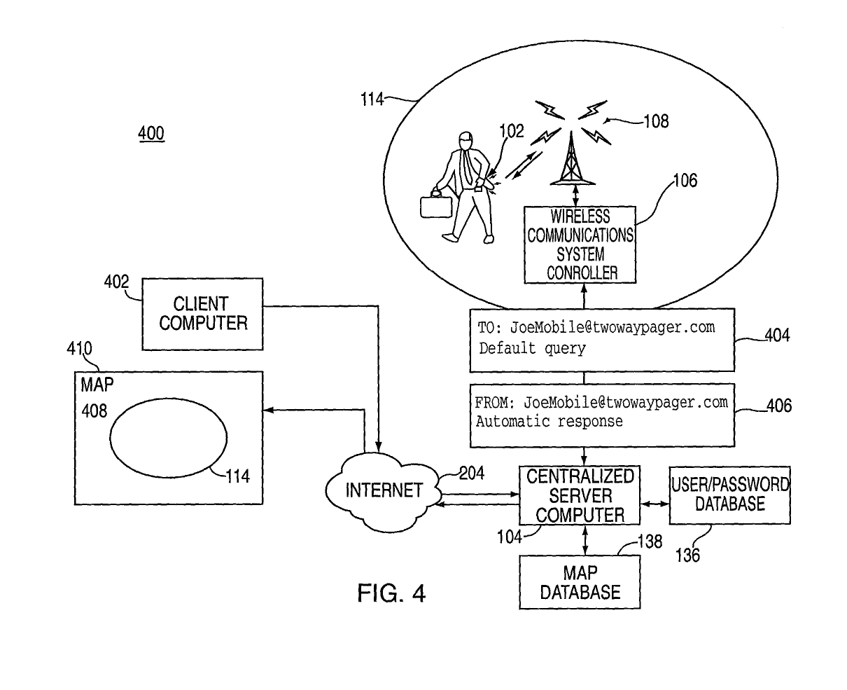

FIG. 4 depicts one embodiment of a system 400 for providing location-based information of a user of a wireless device in response to a message from another user. A first user may utilize the system 400 to determine the location of a second user carrying the wireless device 102.

The first user may use a message sending device, e.g., a client computer 402, to send a message (not shown) to the server computer 104 a network, e.g., the Internet 204 or a Plain Old Telephone System (POTS), to the server computer 104. Although the first user may use the client computer 402 to send the message to the server computer 104, the first user may also use another wireless device (not shown) to transmit a request via a wireless network.

The message is similar to the message 120 of FIGS. 1 and 2. For example, the message may contain a request for location-based information. However, the request is for location-based information of a second user carrying a wireless device 120. The requested location-based information may include a map 408 of the region 114 of the second user, but may also or alternatively include other types of location-based information, e.g., location of hotels in a surrounding region 114.

The server computer 104 operates in substantially the same manner as previously discussed with respect to FIG. 1. For example, the server computer 104 determines whether the message contains a request for location-based information of a second user. In one embodiment, the server computer 104 may also verify the status of the first user. More specifically, the server computer 104 may access the user and password database 136 to determine whether the first user has permission to obtain location-based information for the second user. For example, the server computer 104 may determine whether the first user has included a password previously specified by the second user and stored in the password database 136.

If the first user and password are verified, the server computer 104 uses the wireless network to determine the location of the second user carrying the wireless device 102. In one embodiment, the server computer 104 sends a wireless signal, e.g., a query message or request message 404, to the wireless device 102 via the wireless network. The request message 404 contains the address of the wireless device 102 carried by the second user. The request message 404 is specifically configured to cause the wireless device 102 to automatically send a wireless signal, e.g., a response message 406, back to the server computer 104. For example, if the wireless device 102 is a two-way pager, the automatic response is implemented in accordance to the Reflex 25 protocol.

The wireless system controller 106 of the wireless network may track the location of the wireless device 102. For example, if the wireless device 102 comprises a cellular phone, the location of the cellular phone is periodically provided to the wireless network on a periodic basis, e.g., every twelve minutes. Once this location is known, the wireless network may identify the communications tower closest to the wireless device 102, such that the server computer 102 may transmit the request message 404 to the wireless device 102.

The server computer 104 may extract the location of the second user from the response message 406. Additionally, the server computer 104 may determine the location of the second user in a substantially similar manner as previously described with respect to FIG. 1. Once the location of the second user is determined, the server computer 104 retrieves a map 408 of this location from the map database 138 and transmits the map 408 in the form of a reply message 410 to the client computer 402 of the first user. The map 408 represents at least a portion of the region 114 containing the wireless device 102.

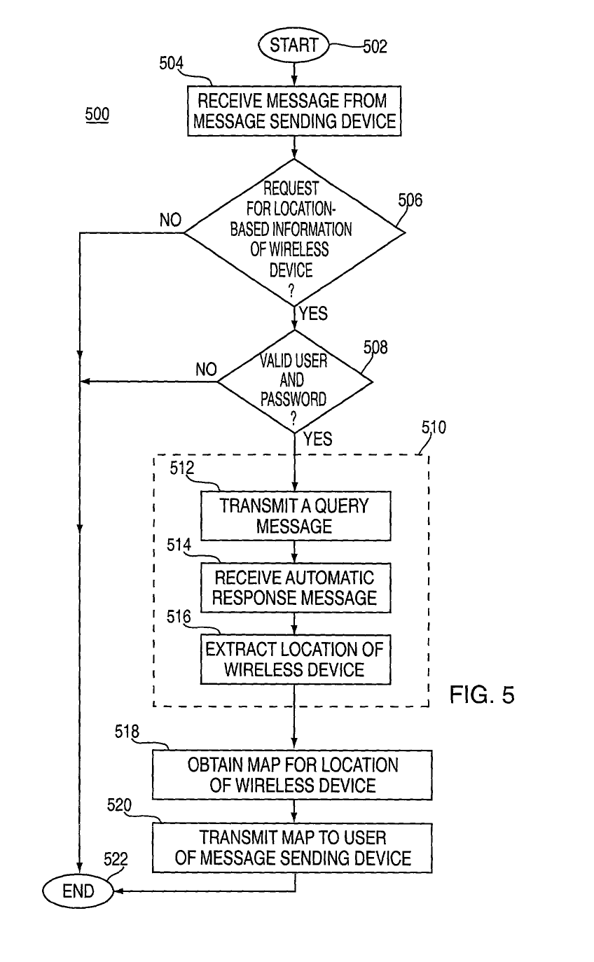

FIG. 5 depicts a flowchart of a method 500 for implementing the system 500 of FIG. 4. The method 500 starts at step 502 and proceeds to step 504, where the server computer 104 receives a message from a first user of a client computer 402 or some other message sending device. The message may contain a request for location-based information of a second user carrying a wireless device 102. The message may also contain a password utilized to verify whether a first user is permitted to request location-based information for the second user. The message may be received via a network, e.g., the Internet, a Plain Old Telephone System (POTS) or a wireless network.

At step 506, the method 500 determines whether the message contains a request for location-based information of the second user. Namely, step 506 determines whether the message contains a pre-defined character string. Step 506 is similar to step 306 of FIG. 3. If the message contains the request for location-based information of the second user, the method proceeds to step 508. If the message contains no such request, the method 500 proceeds to exit at step 522.

At step 508, the method 500 determines whether the first user and password are valid for the system 500. Namely, step 508 performs a database query on the password/user database 136 to verify the first user and password in the message. If either the first user or password is not verified, the method 500 ends at step 522. If both the first user and password are verified, the method proceeds to step 510, where the method 500 determines the location of the second user carrying the wireless device 102.

Step 510 may be implemented in a similar manner to step 310 of FIG. 3. However, in one embodiment, step 510 may also include steps 512, 514 and 516. At step 512, the server computer 104 uses the wireless network to transmit a request message 404 to the wireless device 102. In the case where the wireless device 102 comprises a cellular phone, the system 100 may transmit the request message 404 to the last known communications tower. As cellular phones communicate with the wireless system on a periodic basis, e.g., every twelve minutes, the wireless network is updated with the location of the communications tower 108 most proximate to the wireless device 102 carried by the second user. The request message 404 is configured to cause the wireless device 102 to automatically respond with a reply message 406. In one embodiment, the reply message 406 may be sent in accordance to the Reflex 25 protocol.

The method 500 proceeds to step 514, where the response message 406 is received via the wireless network at the server computer 104. The response message 406 contains the location of the wireless device 102 as determined by the wireless communications system controller 106 or by the server computer 104. At step 516, the method 500 extracts the location of the wireless device 102 from the response message 406. The method 500 proceeds to step 518, where a map 408 of the location of the wireless device 102 is obtained. Namely, step 514 performs a database query of the map database 134 to extract a map 408 of the location of the second user, i.e., the location of the wireless device 102. The map 408 is provided in a reply message 410. The method 500 proceeds to transmit the reply message 410 to the client computer 402 of first user at step 516, and end at step 518.

Although various embodiments which incorporate the teachings of the present invention have been shown and described in detail herein, those skilled in the art can readily devise many other varied embodiments that still incorporate these teachings.

What is claimed is:

1. A method for providing location-based information for a wireless device, the method comprising:
receiving a message from said wireless device via a wireless network;
determining whether the received message contains a request for location-based information;
determining the location of said wireless device using said wireless network if the received message is determined to contain the request;
retrieving location-based information related to the determined location; and
transmitting the location-based information to said wireless device via said wireless network.

2. The method of claim 1 further comprising:
verifying a user of said wireless device prior to retrieving location-based information to said wireless device.

3. The method of claim 2 wherein said verifying comprises:
determining whether the user of said wireless device is listed in a user database.

4. The method of claim 1 wherein said location-based information comprises a location of at least one entity within a region containing of said wireless device.

5. The method of claim 4 wherein said location-based information comprises the location of at least one of gas stations, hotels, cinema, automobile repair facilities, department stores and emergency services.

6. The method of claim 1 wherein said received message comprises an electronic mail message.

7. The method of claim 1 wherein said determining of the received message comprises:
identifying whether the received message contains a predefined character string; and
determining the received message as a request for location-based information if the pre-defined character string is identified in the received message.

8. The method of claim 7 wherein the pre-defined character string is located in at least one of a header, a TO: field, a CC: field, or a body of the received message.

9. The method of claim 7 wherein the pre-defined character string is in one of a text format and a binary format.

10. The method of claim 1 wherein the determining of the received message is automatically identified as a request for location-based information.

11. The method of claim 1 wherein the determining the location comprises:
obtaining the location of said wireless device as determined by a wireless communications system of said wireless network.

12. The method of claim 1 wherein said determining the location comprises:
determining the location of a communications tower previously receiving a wireless signal from said wireless device.

13. The method of claim 1 wherein said determining the location comprises:
determining the location using at least one of time of arrival information, field strength values and global positioning system information.

14. The method of claim 1 wherein the determining the location comprises:
determining the location of at least two communications towers previously receiving a wireless signal from said wireless device; and
calculating the location of said wireless device from the locations of the least two communications towers.

15. The method of claim 14 wherein the calculating comprises:
averaging the location of the at least two communications towers.

16. The method of claim 14 wherein the calculating comprises:
determining the maximum likelihood of the location of the at least two communications towers.

17. A method for providing a location of a wireless device, the method comprising:
receiving a message from a sending device utilized by a first user;
determining whether the received message contains a request for the location of said wireless device carried by a second user;
determining the location of said wireless device using a wireless communications system if the received message is determined to contain the request;
retrieving location-based information representative of the determined location; and
transmitting the location-based information to the first user.

18. The method of claim 17 wherein said received message is provided from at least one of a wireless network, an internet, and a Plain Old Telephone System (POTS).

19. The method of claim 17 further comprising:
verifying whether the first user has permission to obtain the location of the second user carrying said wireless device.

20. The method of claim 17 wherein the location-based information comprises a map of the location of said wireless device carried by the second user.

21. The method of claim 17 wherein said received message comprises an electronic mail message.

22. The method of claim 21 wherein said determining of the received message comprises:
identifying whether the received message contains a pre-defined character string; and
determining the received message as a request for the location of said wireless device if the pre-defined character string is identified in the received message.

23. The method of claim 21 wherein the pre-defined character string is located in at least one of a header, a TO: field, a CC: field, or a body of the received message.

24. The method of claim 21 wherein the pre-defined character string is in one of a text format and a binary format.

25. The method of claim 17 wherein said determining the location comprises:
transmitting a query signal to said wireless device, where said query signal causes said wireless device to respond with a response signal; and
receiving said response signal from said wireless device, where said response signal is configured to include the location of said wireless device.

26. The method of claim 17 wherein said determining the location comprises:
determining the location of a communications tower previously receiving a wireless signal from said wireless device.

27. The method of claim 17 wherein said determining the location comprises:
determining the location using at least one of time of arrival information, field strength values and global positioning system information.

28. The method of claim 17 wherein the determining the location comprises:
determining the location of at least two communications towers previously receiving a wireless signal from said wireless device; and
calculating the location of said wireless device from the locations of the least two communications towers.

29. The method of claim 28 wherein the calculating comprises:
averaging the location of the at least two communications towers.

30. The method of claim 28 wherein the calculating comprises:
determining the maximum likelihood of the location of the at least two communications towers.

31. An apparatus for providing location-based information of a wireless device, the apparatus comprising:
a central processing unit (CPU), for processing a message received at support circuits, determining whether the received message contains a request for location-based information, determining the location of said wireless device using a wireless communications system, and retrieving location-based information related to the identified location;
support circuits, coupled to said CPU and a wireless communications system, for receiving the message, transmitting location-based information to one of said wireless device and a message sending device other than said wireless device; and
a memory, coupled to said CPU, for storing a program that, when executed by the CPU, causes the CPU to perform said processing, said determining of the received message, said determining of the location of said wireless device, and said retrieving.

32. The apparatus of claim 31 wherein said CPU further verifies a user sending the request message to a user database.

33. The apparatus of claim 31 wherein said CPU retrieves location-based information from a map database.

34. The apparatus of claim 31 wherein said CPU receives of at least one of the request for location-based information and operating information from said message sending device using a network.

35. The apparatus of claim 34 wherein said network comprises at least one of a wireless network, an internet, and a Plain Old Telephone System (POTS).

36. The apparatus of claim 31 wherein said CPU configures a reply message containing location-based information retrieved from a map database.

37. The apparatus of claim 36 wherein the reply message further contains operating information retrieved from a data retrieval system.

38. The apparatus of claim 31 wherein said wireless device comprises at least one of a two-way pager, a personal digital assistant (PDA) and a cellular telephone.

39. The apparatus of claim 31 wherein said support circuits operate as a Transmission Control Protocol/Internet Protocol (TCP/IP) interface.

40. The apparatus of claim 31 further comprising:
a wireless communications system controller, coupled to said support circuit, for determining the location of said wireless device.

41. The apparatus of claim 31 wherein said request message is sent from said wireless device.

42. The apparatus of claim 31 wherein said request message is sent from said message sending device to request a map containing the location of said wireless device.

43. The apparatus of claim 31 wherein said location-based information comprises the location of at least one of gas stations, hotels, cinema, automobile repair facilities, department stores and emergency services.

44. The apparatus of claim 31 wherein said location-base information comprises a map of an area surrounding said wireless device.
